(19) United States
(12) Patent Application Publication
(10) Pub. No.: US 2011/0283458 A1
(43) Pub. Date: Nov. 24, 2011

(54) Ticking Layers that Reduce Flame Propagation and Upholstered Articles Incorporating Same

(76) Inventors: Samuel Mark Gillette, Burlington, NC (US); Zareh Mikaelian, Greensboro, NC (US); Ladson L. Fraser, JR., High Point, NC (US); James Douglas Small, JR., Greensboro, NC (US)

(21) Appl. No.: 12/782,247

(22) Filed: May 18, 2010

(51) Int. Cl. A47C 27/00; B32B 27/12; B05D 1/30; B32B 37/00; B32B 37/06; B29C 65/08; B32B 5/02; B32B 37/12

(52) U.S. Cl. 5/698; 428/221; 442/394; 442/286; 442/304; 156/60; 156/308.2; 156/73.1; 427/420

(57) ABSTRACT

A method of producing a ticking includes laminating a flame retardant backer to film material, wherein the backer releases flame retardant in the vapor phase that reduces the rate of flame propagation along the film material, when the ticking layer is exposed to flame. The backer is laminated in direct contact with the film material. In some embodiments, the laminated ticking is configured to release less than 15 MJ of heat in the first ten minutes when exposed to a flame in accordance with the testing protocol set forth in 16 CFR 1633. Upholstered articles, such as mattresses, mattress foundations, and articles of furniture, may incorporate the ticking layer.

### FIELD OF THE INVENTION

The present invention relates generally to upholstered articles and, more particularly, to rendering upholstered articles fire resistant.

### BACKGROUND

There is heightened awareness of fire prevention in homes and businesses in the United States. This awareness has led to the development of standards and legislation directed to reducing the risk of fires, particularly with respect to bedding and upholstered furniture. Conventional fire prevention techniques for bedding and upholstered furniture involve the topical application of flame retardant chemicals directly to an outer decorative layer of upholstery material.

However, recently passed legislation may render conventional fire protection techniques for bedding (particularly mattresses) inadequate. For example, the cigarette burn test for measuring flame resistance (developed by the Upholstered Furniture Action Council) has been deemed inadequate by the state of California and by the U.S. Consumer Product Safety Commission. For example, in January, 2005, California implemented regulatory legislation requiring mattresses to be flame resistant (California Technical Bulletin 603 of the State of California Department of Consumer Affairs, referred to as “TB-603”). Aggressive federal standards for flammability of mattresses set forth by the U.S. Consumer Product Safety Commission require flame resistant construction for all mattresses sold in the United States and are described in the Federal Register at 16 CFR 1633 (hereinafter “16 CFR 1633”), which is incorporated herein by reference in its entirety. The testing specified by 16 CFR 1633 exposes a mattress side and top and a side of a foundation to a gas burner flame. Following the exposure, the mattress and foundation are monitored for thirty minutes to measure heat generation rate and total heat generation.

The top and side panels of a mattress are typically composed of layers of material. For example, the outer layer may be a decorative fabric referred to as ticking or a ticking layer, and which may be a high quality knit or woven textile. Mattress ticking fabrics are generally of loose construction and have a soft, extensible handle. A coating on the back or a laminated fabric on the back may be necessary to provide dimensional stability and wear resistance.

The next layer is typically a cushioning layer (or layers), such as foam, batting, or other lofty, soft material (or combinations of various soft materials). The cushioning layer provides a plump, soft, feel and texture to the panel. The next layer is typically a backing fabric that supports the cushioning material and provides strength and dimensional stability to the panel. The backing layer may be optional if the second layer is strong enough and stable enough to support the structure. Additionally, some mattress or upholstery panels are flat and do not have significant ‘plumping’ or cushioning, but must still provide the insulation and flame resistance required by the new standards. The backing layer is conventionally a polyester or polypropylene nonwoven fabric, a knit, or a woven fabric. The layers of a mattress panel are typically assembled via stitch quilting. Conventionally, a flame and heat blocking component is added to the panel when the panel is designed to resist heat, fire, or ignition.

When mattresses and other upholstered articles having a ticking layer are exposed to fire, or to a test flame challenge, the first material to be exposed is the ticking layer. Ticking fabrics can be made to be flame resistant by finishing the ticking fabric with flame retardant chemicals, or by back-coating the ticking fabric with flame retardant chemicals. Unfortunately, conventional finishing and back coating techniques may cause unacceptable changes to the ticking fabric, such as stiffening, discoloration, fiber blend limitations, and may cause exposure of individuals to chemicals on the sleep surface. Moreover, these conventional finishing and back-coating techniques may have a high degree of variability, may give unreliable performance, and may increase manufacturing costs.

To prevent the ignition of the core of a mattress, the core of an article of upholstered furniture, or other upholstered article, a variety of flame resistant materials have been utilized. For example, fabrics made from graphite, carbon, para-aramid, or other flame and heat resistant fibers have been used. Batting composed of flame resistant fibers or fibers that char, such as silica modified rayon (or Visil), modacrylic, FR rayon, FR polyester, melamine, or other suitable fibers, may be produced such that high basis weights can provide flame resistance and insulation. Foams may be chemically treated with flame retardant or impregnated with graphite. Fabrics may also be treated with flame retardant and/or intumescent chemical compositions or impregnated with intumescent chemicals to provide flame blocking and insulative properties.

Conventional ticking burns rapidly and can generate more than 15MJ of heat in the first 10 minutes when exposed to a flame challenge per 16 CFR 1633 testing. Even though a mattress core is protected with conventional barrier materials, the mattress can fail testing and present significant flammability risk because of the ticking layer, or flaws in the ticking layer. The tendency to propagate flame and spread fire over the ticking surface is detrimental to the performance of upholstery and ticking fabrics used in furniture and mattress construction.

### SUMMARY

In view of the above discussion, flame resistant ticking that reduces flame propagation, and upholstered articles incorporating same, are provided. According to some embodiments of the present invention, a method of producing a flame resistant ticking includes laminating a flame retardant (FR) backer (also referred to as a “backing fabric”, “backing layer”, or “substrate”) to an outer decorative fabric, wherein the backer is configured to release a chemical vapor that reduces the rate of propagation of a flame along the decorative fabric when the decorative fabric is exposed to flame. The backer is laminated in direct contact with the inside surface of the decorative fabric. In some embodiments, the laminated ticking is configured to release less than 15 MJ of heat in the first ten minutes when exposed to a flame in accordance with the testing protocol set forth in 16 CFR 1633.

The decorative fabric may be a woven or nonwoven material and may be laminated to the backer in various ways including, but not limited to, thermal bonding, ultrasonic bonding, adhesive bonding, etc. The backer may be a woven or nonwoven material and may include non thermoplastic material such as viscose, silicic acid modified viscose, wood pulp, cotton, jute, ramie, linen, paper, glass, lyocell, PPS, aramids, novoloid, carbon, melamine, wool, and blends thereof. In some embodiments, the backer may be a film or may be paper.

In some embodiments, the backer includes acid liberating flame retardants that are released when the ticking is exposed to heat or flame. In some embodiments, the backer includes endothermic material that is released when the ticking is exposed to heat or flame and that is configured to cool a flame and reduce flame propagation.

In some embodiments, the backer includes free radical liberating flame retardants that are released when the ticking is exposed to heat or flame and that are configured to emit halogen free radicals and hydrogen halides that can quench a flame on the ticking. In some embodiments, the backer includes a water liberating compound that is released when the ticking is exposed to heat or flame and that cools the ticking and limits flame propagation.

In some embodiments, the backer includes thermoplastic material that is configured to melt into the decorative fabric when the ticking is exposed to heat or flame.

Ticking, according to embodiments of the present invention, may be utilized in mattress panels, as well as in other upholstered articles. Ticking, according to embodiments of the present invention can prevent or reduce flame propagation after exposure to flame. By preventing or reducing flame propagation, the risk of flame movement into the core of a mattress or upholstered article is decreased.

According to some embodiments of the present invention, an upholstered article (e.g., mattress, mattress foundation, article of furniture etc.) includes a flame resistant ticking layer that releases less than 15 MJ of heat in the first ten minutes when exposed to a flame in accordance with the testing protocol set forth in 16 CFR 1633. The ticking layer includes a flame retardant backer laminated in direct face-to-face contact with a decorative fabric. The backer is configured to release a chemical vapor that reduces the rate of flame propagation along the decorative fabric when the decorative fabric is exposed to flame.

In some embodiments, the FR backer includes acid liberating flame retardants selected from the group consisting of: expandable graphite, boric acid, zinc borate, ammonium phosphate, poly ammonium phosphate, phosphate esters, organo-phosphorous compounds, polyphosphazenes, phosphorous, ammonium sulfamate, ammonium bromide, and ammonium chloride. In some embodiments, the backer includes free radical liberating flame retardants selected from the group consisting of: vinyl chloride, decabromo diphenyl oxide, pentabromo dipheny oxide, polyvinylidene chloride, and antimony/halogen mixtures. In some embodiments, the backer includes a water liberating compound selected from the group consisting of hydrated alumina, borax decahydrate, and zinc borate. In some embodiments, the backer comprises a non flammable gas liberating flame retardant selected from the group consisting of: calcium carbonate, melamine, and sodium bicarbonate.

According to other embodiments of the present invention, an upholstered article (e.g., mattress, mattress foundation, article of furniture etc.) includes a flame resistant ticking layer that releases less than 15 MJ of heat in the first ten minutes when exposed to a flame in accordance with the testing protocol set forth in 16 CFR 1633. The ticking layer includes a flame retardant backer laminated in direct face-to-face contact with a film material. The backer is configured to release flame retardant in the vapor phase that reduces the rate of flame propagation along the film material when the ticking layer is exposed to flame. Exemplary film materials may include polyvinyl chloride, polyvinylidene chloride, olefin, polyethylene, polypropylene, urethane, polyamide, nylon, polyester, co-polyester, copolyetherester, copolyetheramide, PTFE, polyvinyl acetate, or ethylene vinyl acetate. The film material may be single layer material or multi-layer material and may have decorative aspects (e.g., color, printing, embossing, etc.).

In some embodiments, the film material and backer may be laminated together using an adhesive, adhesive web, adhesive film, binder fiber, binder powder or adhesive agent. Also, the film material and backer may be laminated together using thermal or ultrasonic bonding. In other embodiments, the film material may be directly extruded onto the backer forming an extrusion laminate.

The backer may be a woven or nonwoven material and may include non thermoplastic material such as viscose, silicic acid modified viscose, wood pulp, cotton, jute, ramie, linen, paper, glass, lyocell, PPS, aramids, novoloid, carbon, melamine, wool, and blends thereof. In some embodiments, the backer may be a film or may be paper. In some embodiments, the backer includes acid liberating flame retardants that are released when the ticking is exposed to heat or flame. In some embodiments, the backer includes endothermic material that is released when the ticking is exposed to heat or flame and that is configured to cool a flame and reduce flame propagation. In some embodiments, the backer includes free radical liberating flame retardants that are released when the ticking is exposed to heat or flame and that are configured to emit halogen free radicals and hydrogen halides that can quench a flame on the ticking. In some embodiments, the backer includes a water liberating compound that is released when the ticking is exposed to heat or flame and that cools the ticking and limits flame propagation. In some embodiments, the backer includes thermoplastic material that is configured to melt into the decorative fabric when the ticking is exposed to heat or flame.

### DETAILED DESCRIPTION

The present invention now is described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “mattress”, as used herein, is intended to include mattresses and mattress foundations (e.g., box springs, etc.), without limitation.

The term “mattress panel”, as used herein, is intended to include panels for mattresses and panels for mattress foundations. Thus, the term “mattress panel” includes panels used to construct mattresses and panels used to construct mattress foundations.

The terms “ticking”, “ticking layer”, and “tick”, as used herein, are interchangeable and refer to the decorative fabric used as an outer surface fabric for an upholstered article, including mattresses, mattress foundations, mattress sets, upholstered furniture, etc.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s). It will be understood that the spatially relative terms are intended to encompass different orientations of a layer or panel in use or operation. For example, if a layer or panel is inverted, elements described as “under” or “beneath” other elements or features would then be oriented “over” the other elements or features. Thus, the exemplary term “under” can encompass both an orientation of “over” and “under.” A layer or panel may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

The “back side” of any mattress panel is defined as the side of the panel that faces the internal core of a mattress/mattress foundation. Accordingly, the “front side” of any mattress panel is the side of the panel that faces outwardly away from the internal core of a mattress/mattress foundation (i.e., the front side is the opposite side from the back side of a panel). A mattress panel front side is the side that will be impinged with a flame according to the various tests described herein and that will be exposed to flame/heat in an actual fire event. Which side of a mattress panel is the front side and which side is the back side would be understood by one skilled in the art of the present invention.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention.

Embodiments of the present invention provide ticking that may be used to help protect internal combustible mattress (and other upholstered articles) materials when exposed to external ignition sources such as open flames or smoldering cigarettes. Applicants have unexpectedly discovered that when a flame resistant backer is laminated to the back side (inside surface) of a ticking layer the resulting composite has significantly improved resistance to flame propagation and spread. Ticking layers according to embodiments of the present invention can replace non-laminated ticking layers, laminated ticking layers having a non flame resistant backing layer, and coated ticking layers.

According to some embodiments of the present invention, lamination of a flame retardant backer may be accomplished by adhesive bonding, thermal bonding, ultrasonic bonding, or other methods known to those skilled in the art. According to some embodiments of the present invention, lamination may include the used of a flame resistant adhesive material or a flame retardant containing adhesive material. Exemplary adhesive agents may include, but are not limited to water-based adhesives, solvent-based adhesives, hot melt adhesives, powder adhesives, web adhesives, and film adhesives.

Applicants have unexpectedly discovered that when a flame retardant backer is in direct contact with a ticking, the composite laminated ticking has reduced flammability, flame propagation, and flame spread, thus preventing a flame from moving across the surface of the article and igniting material away from the initial challenge, as compared to conventional ticking layers (e.g., conventionally laminated ticking layers, coated ticking layers, unbacked ticking layers, etc.).

Flame retardant backers, according to embodiments of the present invention undergo vapor phase activity when ticking laminated thereto is exposed to heat and flame, as described below. In addition, flame retardant backers, according to embodiments of the present invention are excellent in preventing flame propagation, and can stop the movement of flame across a mattress or other upholstered article. Various chemicals may be utilized in a flame retardant backers, according to embodiments of the present invention.

For example, in some embodiments, acid liberating flame retardants such as expandable graphite, boric acid, zinc borate, ammonium phosphate, poly ammonium phosphate, phosphate esters, organo-phosphorous compounds, polyphosphazenes, phosphorous, ammonium sulfamate, ammonium bromide, ammonium chloride, and the like, emit acid vapor that can quench a flame and degrade the fuel component of a ticking layer. In some embodiments, materials that are endothermic, such as ethanolammonium borate, urea, or hydrated alumina, or phase change materials, can cool a flame and reduce flame propagation. The endothermic nature can come from heat of reaction, heat of fusion, phase change, or liberation of bound water,

In some embodiments, free radical liberating flame retardants such as vinyl chloride, decabromo diphenyl oxide, pentabromo dipheny oxide, polyvinylidene chloride, antimony/halogen mixtures, and the like can emit halogen free radicals, and hydrogen halides that can quench a flame above it. In some embodiments, water liberating compounds such as hydrated alumina, borax decahydrate, or zinc borate, can liberate water vapor that may cool a ticking fabric above and limit flame propagation. Additionally, the water liberated from combustion of materials can act to reduce flame propagation. In other embodiments, non flammable gas liberating flame retardants such as calcium carbonate, melamine, or sodium bicarbonate, may liberate gases that rob a flame of oxygen.

According to further embodiments of the present invention, a flame retardant backer may include non thermoplastic materials, such as viscose, silicic acid modified viscose, wood pulp, cotton, jute, ramie, linen, paper, glass, lyocell, PPS, aramids, novoloid, carbon, melamine, wool, blends of these fibers, and the like. Thermoplastic materials including, but not limited to, polyester, nylon, copolyester, polypropylene, poly-vinyl chloride, acrylic and modacrylic fiber, may be used as a minor constituent of a blend.

Flame retardant backers, according to embodiments of the present invention may be a textile, woven or knit, a nonwoven fabric, a film, or a paper or a composite material. Cellulose-containing materials may be desirable since these materials tend to char and are readily available.

Alternately, blends of high temperature fibers such as aramid, novoloid, melamine, glass, carbon, or silicic acid modified viscose, may be used.

According to some embodiments of the present invention, a thermoplastic material, such as polyvinyl chloride, may be positioned such that, when exposed to high temperature, it melts into a ticking fabric and provides a flame resistant function.

Multi-layer flame barriers in mattress panel construction are known; however, these multi-layer structures are intended to be an internal defense to the intrusion of flame and do not have any direct effect on the ticking. Many of these multi-layered structures are lofted to provide thermal resistance, or are composed of silicic acid modified viscose, glass, aramid, melamine, carbon, phenol formaldehyde and the like to stand up to a vigorous flame challenge. In contrast, embodiments of the present invention are not intended to function as a flame barrier, but to add flame resistance and to reduce flame propagation on the outside decorative surface when a mattress or upholstered article is challenged in flame testing or in a fire.

Decorative layers with fire retardant backers, according to embodiments of the present invention, are not limited to use in mattress construction. Various types of upholstered articles may incorporate laminated ticking, according to embodiments of the present invention.

Mattresses utilizing ticking layers having flame retardant backers laminated thereto, according to embodiments of the present invention have numerous advantages over conventional mattresses. For example, because embodiments of the present invention retard the surface spread of fire, a mattress can meet the initial 15MJ limit of heat released in the first ten minutes of a flame test according to 16 CFR 1633. Furthermore, ticking layers according to embodiments of the present invention provide a uniform and stable first line of defense for flame spread across a mattress.

Flame retardant backers can be designed to liberate flame retardant chemistry into the outside ticking layer, thereby preventing or retarding flame propagation. Moreover, the structure of a ticking layer having a laminated flame retardant backer, according to embodiments of the present invention, can improve the dependability of mattress construction, because the risk that certain flame retardant materials can be left out is eliminated.

Other advantages of ticking layers according to embodiments of the present invention include the fact that a ticking layer cannot be thinned by stretching during construction. Furthermore, the laminated backer can provide strength and stability to the ticking in everyday use. In addition, the use of chemical coatings on the decorative layer (e.g., the sleep surface of a mattress, etc.) can be eliminated.

Ticking layers according to embodiments of the present invention can be lighter in weight and lower in cost than conventional flame resistant ticking layers. Accordingly, lighter weight and lower cost ticking layers can reduce the fuel load and manufacturing costs of a mattress. Furthermore, fiber selection and construction are less critical in laminated ticking, according to embodiments of the present invention.

### EXAMPLES

A series of experiments were carried out to evaluate the ability of embodiments of the present invention to accomplish the goal of reducing or eliminating the propagation of flame across the surface ticking of an upholstered article, a mattress, a mattress set, etc. The objectives of the experiment were as follows:
1. Show the effectiveness of the inventive backer to reduce or eliminate flame propagation.
2. Show the ineffectiveness of conventional/alternate backing systems used in the field.
3. Show the necessity of intimate contact between the backing fabric and the ticking fabric.
4. Show the need for a product that out-gasses a flame retardant material on exposure, versus a material that is simply flame proof.
   To accomplish this, a laboratory test was developed that exposes a ticking to a flame challenge per 16-CFR-1633, with only a 3 second exposure time. This allows for ignition and observation of the flame propagation without the severe exposure of the full 16-CFR-1633 test for flame barrier.

Two standard mattress ticking fabrics were obtained as follows:

1. Style 2632; A 3.75 oz/sq. yd. woven sateen tick with a fiber blend of 60% polyester and 40% polypropylene, obtained as a loom state (unfinished) material.

2. Style 2639; A 3.66 oz/sq yd woven sateen tick with a fiber blend of 65% polyester and 35% polypropylene, obtained as a loom state material.

The ticking samples were then subjected to burn testing and a timing of their burn rates and propagation. The tickings were burned alone, backed with polymer, and backed with various fabrics. Both plain and flame retardant adhesives were used.

As illustrated by the experimental data shown below in Table 1, an effective way of controlling the flame propagation of mattress ticking is to bond a backing fabric in intimate contact with a ticking layer, wherein the backing fabric is configured to release a gas phase material on decomposition that can retard flammability and flame propagation.

TABLE 1

| Test item | Ticking | Adhesive | Backing description | Test results and comment |
|---|---|---|---|---|
| 1, laminated ticking to | 2632 | Flame | Spunlaced, 1.55 OSY fabric; | Self extinguishes in 20 seconds. |
| finished ticking backer | | Retardant | 80% viscose, 20% polyester | |
| | | EVA | finished w/phosphate FR | |
| 2, laminated ticking to | 2639 | Flame | As #1 | Self extinguishes in 17 seconds |
| finished ticking backer. | | Retardant | | |
| | | EVA | | |
| 3, as #1 but the ticking | 2632 | None | As #1 | Burned completely to edge in 75 seconds. |
| backer is not laminated | | | | Significant propagation with unlaminated sample |
| 4, as #2 but ticking | 2639 | None | As #1 | Burned completely in 22 sec. |
| backer is not laminated | | | | Significant propagation with unlaminated sample |
| 5, Ticking only | 2639 | None | No backer | Complete burn in 14 sec |
| 6, Ticking only | 2632 | None | No backer | Complete burn in 21 sec |
| 7, Ticking coated with | 2639 | None | Backcoated with acrylic latex | Complete burn in 19 sec |
| acrylic polymer | | | | |
| 8, Ticking coated with | 2632 | None | Backcoated with EVA hot | Complete burn in 30 sec |
| EVA hot melt | | | melt at 0.5 OSY | |
| 9, Ticking coated with | 2639 | None | Backcoated with Flame | Complete burn in 19 sec |
| FR hot melt | | | retardant hot melt at 0.5 OSY | Addition of FR to back coating is ineffective |
| 10, Ticking coated with | 2632 | None | Backcoated with flame | Complete burn in 20 sec |
| FR hot melt | | | retardant hot melt at 0.5 OSY | Addition of FR to back coating is ineffective |
| 11, Ticking laminated to | 2639 | FR EVA | 0.4 oz/sq. yd spunbonded | Complete burn at 36 seconds. |
| spunbond polypropylene | | hot melt | polypropylene | |
| 12, Ticking laminated to | 2639 | 3M solvent | Spunbonded resinated | Complete burn at 26 seconds. Glass does not |
| spun glass nonwoven | | based | fiberglass at 1 oz/sq. yd. | decompose and does not retard combustion or |
| backer. | | adhesive #77 | | propagation. |

According to other embodiments of the present invention, a plastic film material may be used as an outer decorative layer for upholstered articles, including mattresses. The use of plastic film as an outer layer is particularly advantageous where there may be exposure to liquids and/or some type of contamination may arise. For example, mattresses for infants and children, hospitals, incontinent adults, and institutions (e.g., correctional facilities, dormitories, etc.) are all ideal applications for using a film as an outer decorative layer.

In some embodiments, the plastic film may be a halogenated film, such as polyvinyl chloride and polyvinylidene chloride. In other embodiments, the plastic film may be a non-halogenated film, such as olefin, polyethylene, polypropylene, poly lactic acid, urethane, nylon, polyester, polyetherester, polyetheramide, PTFE, poly vinyl acetate, ethylene vinyl acetate, and the like. The film may have flame retardant chemistry such as hydrated alumina or magnesium oxide, or may contain phosphinate, nitrogen based flame retardants or phosphate type additives.

The film material may be a single layer of film or may be a multi-layer film material. In addition, the film material can be a decorative film material. For example, the film material can have color, can have graphics and other indicia printed thereon, and can be embossed with various patterns, shapes, and the like.

The backer (substrate) is configured to retard “afterflame” and prevent a flame from spreading across a mattress or other upholstered article after being exposed to a flame challenge. As known to those skilled in the art of the present invention, the term “afterflame” is the persistence of flame under specified test conditions after an ignition source has been removed. An FR backer, according to embodiments of the present invention, releases flame retardant in the vapor phase that reduces the rate of flame propagation along the film material when the ticking layer (i.e., the laminated film material and FR backer) is exposed to flame.

Table 2 below illustrates afterflame time for various samples where a film material is laminated to a backer.

TABLE 2

| | | | | | AFTER- |
|---|---|---|---|---|---|
| | | BACKER | BURN | BURNING | FLAME |
| SAMPLE | FILM | FABRIC | THROUGH | ON BACK | TIME |
| Control | 6 mil | 1.5 osy | Yes | Total | N/A |
| | PVC | spunbond | | consumption | (Total |
| | | poly- | | | Failure) |
| | | propylene | | | |
| 1 | FR | 80% Rayon | Yes | Total | N/A |
| | olefin | 20% | | consumption | (Total |
| | | polyester | | | Failure) |
| | | spunlace no | | | |
| | | FR | | | |
| 2 | FR | Fiberglass | No | No | 41 sec |
| | olefin | mat | | | |
| 3 | High | FR treated | No | No | 10 sec |
| | FR add | 80% Rayon | | | |
| | olefin | 20% | | | |
| | | polyester | | | |
| | | spunlace | | | |
| 4 | Low | FR treated | No | No | 5 sec |
| | FR add | 80% Rayon | | | |
| | olefin | 20% | | | |
| | | polyester | | | |
| | | spunlace | | | |
| 5 | (no FR) | FR treated | No | No | <10 sec |
| | 6 mil | 80% Rayon | | | |
| | LLDPE | 20% | | | |
| | | polyester | | | |
| | | spunlace | | | |

Each of the samples in Table 2 was exposed to a flame according to procedures set forth in 16 CFR 1633. The control sample, which included an untreated film material and an untreated backer laminated together, failed completely (i.e., was totally consumed in the flame from the source). Similarly, sample 1, which included an FR film and an untreated backer laminated together, failed completely (i.e., was totally consumed in the flame from the source). Sample 2, which included an FR film and a fire resistant backer (fiberglass) laminated together, burned for forty-one seconds (41 sec) after the flame source was removed from the sample. Sample 2 exhibited excessive afterflame, even though fiberglass is a flame resistant material.

Sample 3, which included an extra FR film and an FR backer laminated together, burned for ten seconds (10 sec) after the flame source was removed from the sample. Sample 4, which included a low FR film and an FR backer laminated together, burned for only five seconds (5 sec) after the flame source was removed from the sample. Sample 5, which included a non-FR film and an FR backer laminated together, burned for less than ten seconds (<10 sec) after the flame source was removed from the sample. Table 2 illustrates that the samples backed with a flame retardant treated backing fabric had acceptable results in the lab scale 16 CFR 1633 testing.

The foregoing is illustrative of the present invention and is not to be construed as limiting thereof. Although a few exemplary embodiments of this invention have been described and several examples provided, those skilled in the art will readily appreciate that many modifications are possible in the exemplary embodiments without materially departing from the novel teachings and advantages of this invention.

That which is claimed is:

1. An upholstered article, comprising a ticking layer that releases less than 15 MJ of heat in the first ten minutes when exposed to a flame in accordance with the testing protocol set forth in 16 CFR 1633, wherein the ticking layer comprises a flame retardant backer laminated in direct face-to-face contact with an outer film material, wherein the backer releases flame retardant in the vapor phase that reduces the rate of flame propagation along the film material when the ticking layer is exposed to flame.

2. The upholstered article of claim 1, wherein the film material comprises polyvinyl chloride, polyvinylidene chloride, olefin, polyethylene, polypropylene, urethane, polyamide, nylon, polyester, co-polyester, copolyetherester, copolyetheramide, PTFE, polyvinyl acetate, or ethylene vinyl acetate.

3. The upholstered article of claim 1, wherein the film material and backer are laminated together using an adhesive, adhesive web, adhesive film, binder fiber, binder powder or adhesive agent.

4. The upholstered article of claim 1, wherein the film material and backer are laminated together using thermal or ultrasonic bonding.

5. The upholstered article of claim 1, wherein the film material is directly extruded onto the backer forming an extrusion laminate.

6. The upholstered article of claim 1, wherein the backer comprises acid liberating flame retardants selected from the group consisting of: expandable graphite, boric acid, zinc borate, ammonium phosphate, poly ammonium phosphate, phosphate esters, organo-phosphorous compounds, polyphosphazenes, phosphorous, ammonium sulfamate, ammonium bromide, and ammonium chloride.

7. The upholstered article of claim 1, wherein the backer comprises endothermic material.

8. The upholstered article of claim 7, wherein the endothermic material comprises ethanolammonium borate, urea, and/or hydrated alumina.

9. The upholstered article of claim 1, wherein the backer comprises free radical liberating flame retardants selected from the group consisting of: vinyl chloride, decabromo diphenyl oxide, pentabromo dipheny oxide, polyvinylidene chloride, and antimony/halogen mixtures.

10. The upholstered article of claim 1, wherein the backer comprises a water liberating compound selected from the group consisting of hydrated alumina, borax decahydrate, and zinc borate.

11. The upholstered article of claim 1, wherein the backer comprises a non flammable gas liberating flame retardant selected from the group consisting of: calcium carbonate, melamine, and sodium bicarbonate.

12. The upholstered article of claim 1, wherein the backer comprises non thermoplastic material selected from the group consisting of: viscose, silicic acid modified viscose, wood pulp, cotton, jute, ramie, linen, paper, glass, lyocell, PPS, aramids, novoloid, carbon, melamine, wool, and blends thereof.

13. The upholstered article of claim 1, wherein the backer comprises nonwoven fabric, woven fabric, knit fabric, film, and/or paper.

14. The upholstered article of claim 1, wherein the backer comprises thermoplastic material configured to melt into the film material when exposed to heat above a predetermined temperature.

15. The upholstered article of claim 1, wherein the upholstered article is a mattress, mattress foundation, or article of furniture.

16. An upholstered article, comprising a ticking layer that comprises:
a flame retardant backer comprising at least one of the following: an acid liberating flame retardant, a free radical liberating flame retardant, a water liberating compound, and a non flammable gas liberating flame retardant; and
an outer layer of film material laminated in direct face-to-face contact with the backer, wherein the backer releases flame retardant in the vapor phase that reduces the rate of flame propagation along the film material when the ticking layer is exposed to flame, wherein the film material comprises polyvinyl chloride, polyvinylidene chloride, olefin, polyethylene, polypropylene, urethane, polyamide, nylon, polyester, co-polyester, copolyetherester, copolyetheramide, PTFE, polyvinyl acetate, or ethylene vinyl acetate.

17. The upholstered article of claim 16, wherein the ticking layer releases less than 15 MJ of heat in the first ten minutes when exposed to a flame in accordance with the testing protocol set forth in 16 CFR 1633.

18. The upholstered article of claim 16, wherein the film material and backer are laminated together using an adhesive, adhesive web, adhesive film, binder fiber, binder powder or adhesive agent.

19. The upholstered article of claim 16, wherein the film material and backer are laminated together using thermal or ultrasonic bonding.

20. The upholstered article of claim 16, wherein the film material is directly extruded onto the backer forming an extrusion laminate.

21. The upholstered article of claim 16, wherein the backer comprises endothermic material.

22. The upholstered article of claim 21, wherein the endothermic material comprises ethanolammonium borate, urea, and/or hydrated alumina.

23. The upholstered article of claim 16, wherein the acid liberating flame retardants are selected from the group consisting of: expandable graphite, boric acid, zinc borate, ammonium phosphate, poly ammonium phosphate, phosphate esters, organo-phosphorous compounds, polyphosphazenes, phosphorous, ammonium sulfamate, ammonium bromide, and ammonium chloride.

24. The upholstered article of claim 16, wherein the free radical liberating flame retardants are selected from the group consisting of: vinyl chloride, decabromo diphenyl oxide, pentabromo dipheny oxide, polyvinylidene chloride, and antimony/halogen mixtures.

25. The upholstered article of claim 16, wherein the water liberating compound is selected from the group consisting of hydrated alumina, borax decahydrate, and zinc borate.

26. The upholstered article of claim 16, wherein the non flammable gas liberating flame retardant is selected from the group consisting of: calcium carbonate, melamine, and sodium bicarbonate.

27. The upholstered article of claim 16, wherein the backer comprises non thermoplastic material selected from the group consisting of: viscose, silicic acid modified viscose, wood pulp, cotton, jute, ramie, linen, paper, glass, lyocell, PPS, aramids, novoloid, carbon, melamine, wool, and blends thereof.

28. The upholstered article of claim 16, wherein the backer comprises nonwoven fabric, woven fabric, knit fabric, film, and/or paper.

29. The upholstered article of claim 16, wherein the backer comprises thermoplastic material configured to melt into the film material when exposed to heat above a predetermined temperature.

30. The upholstered article of claim 16, wherein the upholstered article is a mattress, mattress foundation, or article of furniture.

31. A method of producing a ticking, comprising laminating a flame retardant backer to a film material in direct face-to-face contact, wherein the backer releases flame retardant in the vapor phase that reduces the rate of flame propagation along the film material when the ticking layer is exposed to flame, wherein the film material comprises polyvinyl chloride, polyvinylidene chloride, olefin, polyethylene, polypropylene, urethane, polyamide, nylon, polyester, co-polyester, copolyetherester, copolyetheramide, PTFE, polyvinyl acetate, or ethylene vinyl acetate, and wherein the ticking releases less than 15 MJ of heat in the first ten minutes when the ticking is exposed to a flame in accordance with the testing protocol set forth in 16 CFR 1633.

32. The method of claim 31, wherein the film material and backer are laminated together using an adhesive, adhesive web, adhesive film, binder fiber, binder powder or adhesive agent.

33. The method of claim 31, wherein the film material and backer are laminated together using thermal or ultrasonic bonding.

34. The method of claim 31, wherein the film material and backer are laminated together by directly extruding the film material onto the backer.

35. The method of claim 31, wherein the backer comprises acid liberating flame retardants selected from the group consisting of: expandable graphite, boric acid, zinc borate, ammonium phosphate, poly ammonium phosphate, phosphate esters, organo-phosphorous compounds, polyphosphazenes, phosphorous, ammonium sulfamate, ammonium bromide, and ammonium chloride.

36. The method of claim 31, wherein the backer comprises an endothermic material selected from the group consisting of ethanolammonium borate, urea, and/or hydrated alumina.

37. The method of claim 31, wherein the backer comprises free radical liberating flame retardants selected from the group consisting of: vinyl chloride, decabromo diphenyl oxide, pentabromo dipheny oxide, polyvinylidene chloride, and antimony/halogen mixtures.

38. The method of claim 31, wherein the backer comprises a water liberating compound selected from the group consisting of hydrated alumina, borax decahydrate, and zinc borate.

39. The method of claim 31, wherein the backer comprises a non flammable gas liberating flame retardant selected from the group consisting of: calcium carbonate, melamine, and sodium bicarbonate.

40. The method of claim 29, wherein the backer comprises non thermoplastic material selected from the group consisting of: viscose, silicic acid modified viscose, wood pulp, cotton, jute, ramie, linen, paper, glass, lyocell, PPS, aramids, novoloid, carbon, melamine, wool, and blends thereof.

41. The method of claim 31, wherein the backer comprises nonwoven fabric, woven fabric, knit fabric, film, and/or paper.

42. The method of claim 31, wherein the backer comprises thermoplastic material configured to melt into the film material when exposed to heat above a predetermined temperature.
